(19) United States
(12) Patent Application Publication
(10) Pub. No.: US 2014/0056582 A1
(43) Pub. Date: Feb. 27, 2014

(54) DETECTING AND COMMUNICATING POTENTIAL OPTICAL FIBER ISSUES IN OPTICAL NETWORKS

(71) Applicant: Harold A. Roberts, Prior Lake, MN (US)

(72) Inventor: Harold A. Roberts, Prior Lake, MN (US)

(73) Assignee: CALIX, INC., Petaluma, CA (US)

(21) Appl. No.: 13/595,444

(22) Filed: Aug. 27, 2012

(51) Int. Cl. H04B 10/08

(52) U.S. Cl. 398/20; 398/28

(57) ABSTRACT

In general, techniques are described to detect potential issues with optical fibers. The techniques may be implemented using various optical network hardware. An example optical network unit (ONU) includes a network interface coupled to an optical fiber through which the ONU communicates with an optical line terminal (OLT). The ONU further includes a control unit that determines at least a first signal strength and a second signal strength of a signal received via the optical fiber, determines a rate of signal strength degradation based on the first signal strength and the second signal strength, compares the rate of signal strength degradation to a rate threshold so as to determine a potential issue with the optical fiber, and based on the comparison, causes the network interface to send a message to the OLT indicating a potential issue with the optical fiber to which the ONU connects to communicate with the OLT.

### TECHNICAL FIELD

The present disclosure generally relates to computer networks, and more particularly, to detecting potential issues with optical fiber in optical networks.

### BACKGROUND

An optical network, such as a passive optical network (PON), often delivers voice, video and/or other data among multiple network nodes. A PON is an example of a so-called “point-to-multipoint” network. A PON may conform to any of a variety of PON standards, such as broadband PON (BPON) (ITU G.983), gigabit-capable PON (GPON) (ITU G.984), or gigabit Ethernet PON (GEPON) (IEEE 802.3). The architecture of a point-to-multipoint network commonly includes a single central device that communicates with multiple network nodes. In the example of a PON, the central device is often referred to as an optical line terminal (OLT), and the network nodes are often referred to as optical network units (ONUs) or optical network terminals (ONTs). The OLT delivers data to multiple ONUs using a common optical fiber link. Passive optical splitters and combiners enable multiple ONUs to share the common optical fiber link. The optical line terminal (OLT) transmits information downstream to the ONUs, and receives information transmitted upstream from the ONUs. Each ONU terminates the optical fiber link for a residential or business subscriber, and is sometimes referred to as a subscriber or customer premises node.

The optical fibers, splitters, combiners, and other components positioned between the OLT and the ONUs are often collectively known as the optical distribution network (ODN). In a PON, an optical splitter enables downstream communication by demultiplexing optical signals from the OLT and forwarding each demultiplexed optical signal to the appropriate ONU. Similarly, the optical splitter enables upstream communication by multiplexing optical signals from multiple ONUs and forwarding the multiplexed optical signal to the OLT. An optical splitter may be connected to the OLT via a single optical fiber, and to each ONU by a single, separate optical fiber.

In accordance with certain PON standards, such as the GPON standard, an ONU may transmit a message to the OLT even after the ONU experiences a loss of power. That is, an ONU may be equipped with one or more so-called “hold-up capacitors,” which may store sufficient power to enable the ONU to send an upstream message referred to as a “DYING_GASP” or “last gasp” after a failure of the ONU's traditional power source (e.g., an A/C power source). The DYING_GASP message may include information that identifies the sending ONU so that, upon receipt of this message, the OLT may trigger an alert that identifies the ONU that has lost power. This alert may notify a network administrator of the loss of power so that the network administrator may rectify the loss of power and restore communication with the affected ONU. While sending messages of these types may promote identification of ONUs that have lost power and facilitate network administration, the additional hardware, such as the hold-up capacitors, necessary to send these messages may increase the costs associated with and complexity of the ONUs.

Additionally, these DYING_GASP messages do not identify ONUs that have lost communication with the OLT for other reasons, such as a cut or bent optical fiber that couples the ONU to the OLT. To overcome these issues with optical fibers, OLTs may be adapted to monitor the optical delivery network (ODN), which refers to the portion of a passive optical network coupling the OLT to the ONU. OLTs may be adapted to include Optical Time Domain Reflectometers (OTDRs), which is a dedicated component for monitoring optical reflections. Based on the monitored optical reflections, OTDRs may detect bent or cut optical fibers in the ODN, permitting network administrators to identify some problems in the ODN such as a bend or cut and potentially the location (or approximate location) along the fiber that has been bent or cut. In many implementations, OTDRs may be used to determine fiber bends or breaks between an OLT and an optical splitter positioned downstream of the OLT. While enabling network administrators to identify bent or cut optical fibers and thereby facilitating identification of ODN communication issues, integrated OTDRs are often very expensive components that substantially increase the costs of OLTs.

### SUMMARY

In general, techniques of this disclosure may utilize existing ONU hardware to provide for early detection of potential connectivity issues with an optical fiber by which an ONU and an OLT communicate, and communication of the potential issues before a complete loss of connectivity. As a result of utilizing existing ONU hardware to detect the connectivity issues, the techniques may avoid incorporating expensive dedicated equipment at either the OLT or the ONU to detect these types of connectivity issues. Additionally, in contrast to OTDR-based implementations, the techniques may function comparably well in so-called “feeder,” “distribution,” or “drop” sections of an ODN. An ONU may implement the techniques to identify itself and/or the nature of the potential problem (e.g., permanently bent optical fiber, potential fiber cut in the immediate future, etc.). In some implementations, the ONU may adapt messages defined in various PON standards, such as a so-called “DYING_GASP” message specified in a gigabit PON (GPON) standard, to alert the OLT to the potential issue. In response to this DYING_GASP message, the OLT may implement the techniques to trigger an alert that identifies the ONU and/or the fiber experiencing the issue. In this way, the techniques described in this disclosure may utilize existing ONU hardware to detect connectivity issues without increasing the complexity or cost of either OLTs or ONUs, thereby potentially promoting cost savings.

In one example, a method includes determining, by an optical network unit (ONU), at least a first signal strength and a second signal strength of a signal received via an optical fiber to which the ONU connects to communicate with an optical line terminal (OLT), and determining, by the ONU, a rate of signal strength degradation based on the first signal strength and the second signal strength. The method further includes comparing, by the ONU, the rate of signal strength degradation to a rate threshold so as to determine a potential issue with the optical fiber, and based on the comparison, sending, by the ONU, a message to the OLT indicating the potential issue with the optical fiber to which the ONU connects to communicate with the OLT.

In another example, an optical network unit (ONU) includes a network interface coupled to an optical fiber through which the ONU communicates with an optical line terminal (OLT). The ONU further includes a control unit that determines at least a first signal strength and a second signal strength of a signal received via the optical fiber, determines a rate of signal strength degradation based on the first signal strength and the second signal strength, compares the rate of signal strength degradation to a rate threshold so as to determine a potential issue with the optical fiber, and based on the comparison, causes the network interface to send a message to the OLT indicating a potential issue with the optical fiber to which the ONU connects to communicate with the OLT.

In another example, a computer-readable device includes instructions. The instructions cause a programmable processor of an optical network unit (ONU) to determine at least a first signal strength and a second signal strength of a signal received via an optical fiber to which the ONU connects to communicate with an optical line terminal (OLT), determine a rate of signal strength degradation based on the first signal strength and the second signal strength, and compare the rate of signal strength degradation to a rate threshold so as to determine a potential issue with the optical fiber, and based on the comparison, send a message to the OLT indicating a potential issue with the optical fiber to which the ONU connects to communicate with the OLT.

In another example, a method includes receiving, by an optical line terminal (OLT) from an optical network unit (ONU), a message via an optical fiber to which the OLT connects to communicate with the ONU, where the message indicates a potential issue with the optical fiber. The method further includes, in response to receiving the message from the ONU, determining, by the OLT, whether the OLT is able to communicate with the ONU via the optical fiber to which the OLT connects to communicate with the ONU, and based on the determination of whether the OLT is able to communicate with the ONU, generating an alert indicating that the optical fiber to which the OLT connects to communicate with the ONU has failed.

In another example, an optical line terminal (OLT) includes a network interface coupled to an optical fiber through which the OLT communicates with an optical network unit (ONU), where the network interface receives, from the ONU, a message via the optical fiber, and the message indicates a potential issue with the optical fiber. The OLT further includes a control unit that determines, in response to receiving the message from the ONU, whether the OLT is able to communicate with the ONU via the optical fiber to which the OLT connects to communicate with the ONU, and based on the determination, generates an alert indicating that the optical fiber to which the OLT connects to communicate with the ONU has failed.

In another example, a network system includes a public network and at least one optical network unit (ONU). The ONU includes an ONU network interface coupled to an optical fiber through which the ONU communicates with an upstream optical network device, and an ONU control unit that determines at least a first signal strength and a second signal strength of a signal received via the optical fiber, determines a rate of signal strength degradation based on the first signal strength and the second signal strength, and compares the rate of signal strength degradation to a rate threshold so as to determine a potential issue with the optical fiber, and based on the comparison, causes the ONU network interface to send a message to the upstream optical network device indicating a potential issue with the optical fiber to which the ONU connects to communicate with the OLT. The network system further includes an optical line terminal (OLT) that forms at least a portion of the upstream optical network device. The OLT includes an OLT network interface coupled to the optical fiber, where the OLT network interface receives the message indicating the potential issue with the optical fiber. The OLT further includes an OLT control unit that determines, in response to receiving the message from the ONU, whether the OLT is able to communicate with the ONU via the optical fiber to which the OLT connects to communicate with the ONU, and based on the determination, generates an alert indicating that the optical fiber to which the OLT connects to communicate with the ONU has failed.

The techniques described herein may provide certain advantages. For example, an ONU may detect a potential issue (bend, impending cut, etc.) with an optical fiber before the issue causes the ONU to lose connectivity over the PON. Additionally, based on the early detection, the ONU may send a message to the OLT to notify the OLT of the potential issue. In accordance with various PON standards, such as the GPON standard, many existing ONUs may already include the necessary hardware and software to implement these techniques. As a result, the techniques may be implemented on many existing ONUs while incurring little or no additional cost. Additionally, an OLT may implement the techniques to trigger an alert (e.g., to a network administrator) as to an issue with an optical fiber associated with the ONU. The network administrator may then be able to take action to rectify the issue with the optical fiber and restore service to the ONU. As another potential advantage, the ONU may generate alerts that may be used to differentiate between different types of ONU issues, such as fiber failure, power-supply failure, transceiver failure, and others, thus enabling network administrators to determine a suitable course of action to rectify the issue. Additionally, the techniques may assist in distinguishing between overall PON failures and failure of a single optical fiber line, using existing ONU and OLT hardware.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example network system that includes an issue with an optical fiber, an optical network unit (ONU) that detects the issue and communicates the issue upstream, and an optical line terminal (OLT) that generates an alert based on the issue communicated by the ONU, in accordance with one or more aspects of this disclosure.

FIG. 2 is a block diagram illustrating an example ONU that detects an issue with an optical fiber to which the ONU is connected, and communicates the issue upstream using an adapted DYING_GASP message, in accordance with one or more aspects of this disclosure.

FIG. 3 is a block diagram illustrating an example OLT that receives an adapted DYING_GASP message from an ONU indicating an issue with an optical fiber, determines connectivity to the ONU that sent the message, and generates an alert based on the message and the determined connectivity, in accordance with one or more aspects of this disclosure.

FIGS. 4A & 4B are graphs illustrating signal degradation in an optical fiber caused by bending of the optical fiber.

FIG. 5 is a flowchart illustrating an example process by which an example ONU may implement the techniques of this disclosure to detect an issue with an optical fiber and communicate the issue upstream using an adapted DYING_GASP message.

FIG. 6 is a flowchart illustrating an example process by which an example OLT may implement the techniques of this disclosure to receive an adapted DYING_GASP message from an ONU to indicate an issue with an optical fiber, determine whether the OLT is able to communicate with the ONU, and generate an alert based on the received message and the determination.

FIG. 7 is a block diagram illustrating an example structure of an adapted DYING_GASP message, in accordance with one or more aspects of this disclosure.

### DETAILED DESCRIPTION

In general, this disclosure is directed to techniques to identify and communicate potential issues with an optical fiber that runs to an ONU. An optical network, such as a PON, relies on “fiber-optic communication” to connect the OLT and ONUs through the ODN. Fiber optic communication is largely based on transmission of information over optical fibers. Optical fibers provide several advantages over other types of communication media, such as insulated metal wires. For example, optical fibers permit signals to travel longer distances with less or no loss of quality. In other words, optical fibers offer greater bandwidth over longer physical distances. As a result, networks using fiber optic communications have gained popularity in the communications industry.

Optical fibers are typically made of silica (or “pure glass”), and usually have a diameter in the order of micrometers. These properties of optical fibers make optical fibers less malleable than other types of electronic communication media, such as insulated metal wires (e.g., copper wires). When deployed over longer distances, and particularly when deployed to customer premises, optical fibers may be subject to physical manipulation (e.g., bending) to successfully connect to the requisite endpoints. Additionally, such optical fibers may be subjected to extenuating conditions, such as natural elements and man-made damage. As one common example, buried optical fibers are often cut by construction equipment, such as backhoes.

In addition to the physical limitation of poor malleability, the transmission capability of optical fiber is also vulnerable to commonly encountered conditions. For example, a bend in an optical fiber tends to cause significant degradation in data transmission. In contrast, insulated metal wires (e.g., coaxial cables) may be bent and curved to accommodate various conditions without a significant loss of transmission capability. As a result, installers who are accustomed to installing coaxial cables may be prone to bending optical fiber lines to reach the designated endpoint (often an ONU). As discussed, such bending of the optical fiber may cause a significant drop in the optical fiber's transmission capabilities. Additionally, such bending may make the optical more prone to a cut in the future.

If an optical fiber connecting to an ONU is cut, the ONU loses connectivity over the optical network. If the optical fiber is bent, the bend radius may cause the ONU to lose some or all of its ability to communicate over the optical network. Additionally, in a PON, an OLT may not identify a non-communicative ONU for some length of time. More specifically, according to the various PON standards, each ONU transmits upstream communication in a pre-assigned time slice. Each instance of upstream communication from an ONU is known as an “upstream burst.” If an ONU loses connectivity due to a fiber cut or bend, the OLT may not be able to identify the problem until the ONU's next allotted time for an upstream burst. As a result, diagnosing an issue with an optical fiber and identifying which optical fiber has the issue can become time-consuming.

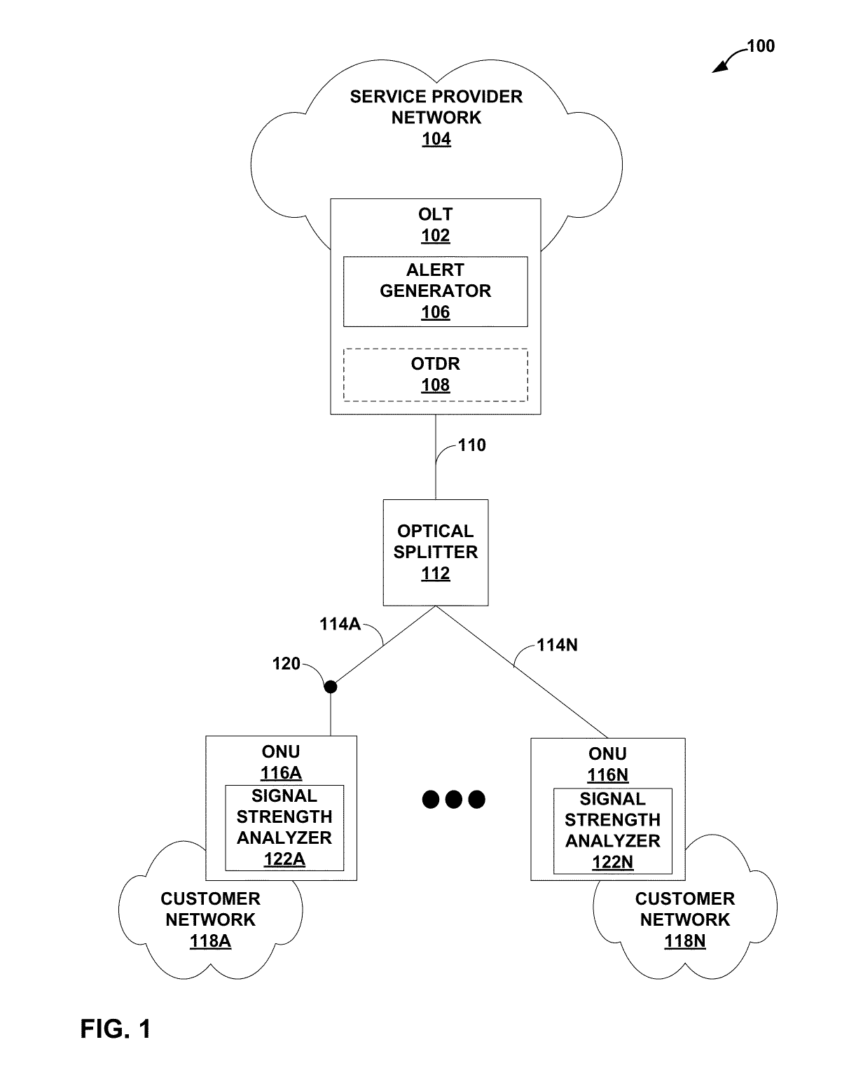

FIG. 1 is a conceptual diagram illustrating a network system 100 that includes an issue (bend 120) with an optical fiber line 114A, an optical network unit (ONU) 116A that detects the issue and communicates the issue upstream, and an optical line terminal (OLT) 102 that generates an alert based on the issue communicated by the ONU. Network system 100 may conform to any of a variety of optical network standards that utilize bit transitions to synchronize timing, such as broadband PON (BPON) (ITU G.983), gigabit capable PON (GPON) (ITU G.984), XGPON or 10G-PON (ITU 987), gigabit Ethernet PON (GEPON) (IEEE 802.3), active optical network (AON) (IEEE 802.3ah), and the like. For purposes of illustration only, network system 100 is assumed to represent a system that conforms to the GPON standard. While described with respect to a particular type of system, i.e., one that conforms to the GPON standard, the techniques may be implemented by any network system that relies on the integrity of optical fibers to maintain connectivity, and acceptable quality thereof.

In the example shown in FIG. 1, network system 100 includes a service provider network 104 and customer networks 118A-118N (“customer networks 118”). Service provider network 104 represents a network that is commonly owned and operated by a service provider to provide one or more services to customer networks 118. Service provider network 104 may provide a number of different services to customer networks 118, including a voice service (often in the form of voice over Internet protocol or VoIP), a data service (which may be referred to as an Internet service or data plan) and a video service (which may be referred to as Internet protocol television or IPTV). Service provider network 104 is often a layer-three packet switched network that implements the third layer of the Open System Interconnection (OSI) reference model, where reference to layers in this disclosure may refer to layers of this OSI reference model.

Customer networks 118 may represent any network that is owned and operated by a customer of the service provider. Customer networks 118 may each include customer premise equipment (CPE), which are not shown in the example of FIG. 1 for ease of illustration purposes. CPE represent any device that may consume one or more of the services to which the corresponding customer subscribes. Examples of CPE may include television set-top boxes, telephones, tablet computers, laptop computers, workstations, desktop computers, netbooks, mobile phones (including so-called “smart phones”), video gaming devices, Internet-ready televisions, Internet-ready disc players, portable gaming devices, personal digital assistant (PDA) devices, routers, hubs, gateways, printers or any other device capable of receiving or otherwise interfacing with the services provided via service provider network 104.

Customer networks 118 are increasingly demanding more bandwidth within service provider network 104 to increasingly receive more and more services via the Internet rather than via separate communication systems (such as a cable coaxial network to receive television broadcasts or a plain old telephone system to receive voice calls). Moreover, service providers may increasingly prefer to maintain only a single data network for administrative and cost reasons, leading to a network architecture where all services are converging on the packet switched network for delivery to customer networks 118. While cable networks and the plain old telephone system (POTS) may support delivery of data services in conjunction with either video or voice, these networks do not commonly provide sufficient bandwidth to support all three, especially as delivery of video data is increasingly requiring ever growing amounts of bandwidth (considering that higher-resolution video is currently in high demand by many customers and requires significantly more bandwidth to deliver due to the higher resolution).

To meet both current demand and expected customer demand going forward, many service providers are forgoing previous cable networks or POTS to provide optical networks as the “last mile,” meaning the last mile to the customer. Optical networks provide large amounts of bandwidth to the customer at considerable speeds. Network system 100 may represent one example of an optical network that is coupled to customer networks 118 via optical link 110, splitter 112 and optical fiber lines 114A-114N (“optical fiber lines 114”). Network system 100 may comprise a passive optical network (PON) or an active optical network (such as those referred to as an active Ethernet (AE) optical network). Regardless, network system 100 may conform to one of the standards referenced above.

Network system 100 includes an optical line terminal 102 (“OLT 102”) and optical network units 116A-116N (“ONUs 116”). OLT 102 terminates the line coupling customer networks 118 to service provider network 104, while ONUs 116 each provide one or more interfaces between customer networks 118 and service provider network 104. OLT 102 generally represents any optical device that aggregates traffic from ONUs 116 for delivery upstream via service provider network 104 to the Internet or other destination and separates traffic from the Internet or other source for delivery downstream to separate customer networks 118.

In the example of FIG. 1, OLT 102 is coupled to optical splitter 112 using optical fiber line 110. As shown in FIG. 1, optical splitter 112 may further be coupled to one or more ONUs 116 using optical fiber lines 114. In some examples, optical splitter 112 receives data from OLT 102 in the form of an “optical signal” and distributes the optical signal to each of ONUs 116. More specifically, optical splitter 112 “splits” this optical signal to generate multiple copies of the received optical signal, transmitting a copy to each of ONUs 116. In these and other examples, optical splitter 112 may split an optical signal by first identifying a set of wavelengths included in the optical signal, and then generating multiple optical signals, each including a different subset of the set of wavelengths. For purposes of illustration only, and in accordance with the GPON standard, optical splitter 112 is presumed to be a so-called “passive optical splitter,” i.e. optical splitter 112 splits an optical signal received from OLT 102 by generating multiple copies (or “optical sub-signals”) of the signal and distributes the optical sub-signals to ONUs 116 using optical fiber lines 114 in the example of GPON without actively switching the sub-signals to the appropriate ones of ONUs 116 or requiring powered components. In some examples, optical splitter 112 may include, be part of, or be coupled to an optical combiner. In these examples, optical splitter 112 may receive optical sub-signals from ONUs 116, then multiplex the received optical sub-signals into a combined optical signal, and then transmit the combined optical signal to OLT 112.

Each of ONUs 116 couples to customer networks 118. In some examples, one or more of customer networks 118 may represent an enterprise network. Some enterprise networks may support enterprises that provide critical or highly-sought after products, care or functions, such as hospitals that may own and operate customer network 118A, for example, to deliver life-saving care. In this example, ONU 116A may receive and transmit data that includes prescriptions, patients' medical records, and medical images such as X-rays and MRIs, and a wide variety of other medical data. Should customer network 118A lose connectivity to the services offered by service provider network 104, the doctors, nurses and other medical staff may be unable to retrieve this medical data and use this data to provide care required by their patients, which again may be potentially life-saving. Consequently, some customers may require a high level of reliability in receiving services provided by service provider network 104.

One way in which OLT 102 and ONUs 116 lose connectivity (or connection quality) is related to cuts and/or bends in optical fiber lines 110 and 114. Though the potential issues described herein may apply to any one or more of optical fiber lines 110 and 114, these potential issues will be described with respect to optical fiber line 114A, for ease of discussion. In the example of FIG. 1, optical fiber line 114A includes bend 120. As discussed, bend 120 may be caused by various factors, such as elements of nature, man-made conditions, etc. Bend 120 may cause signal degradation (such as diminished signal strength) of communications relayed over optical fiber line 114A. In other words, communications between ONU 116A and OLT 102, in both upstream and downstream directions, may be detrimentally affected by bend 120.

To detect issues such as bend 120, it has been proposed to enhance OLT 102 with optional components such as OTDR 108. Alternatively, a network administrator may use a traditional OTDR, which may be a standalone device, by disconnecting optical link 110 from OLT 102 and connecting optical link 110 to the traditional OTDR. As described, OTDRs are often expensive components, and as such, detecting issues such as bend 120 may be an expensive endeavor when implemented using OTDR 108 or a standalone OTDR. In turn, OTDR 108 may alert a network administrator to connectivity issues, such as bend 120, while the issues is at a nascent stage (e.g., within seconds in some cases).

Nevertheless, as discussed, the threat of lost reliability due to issues such as bend 120, cuts to optical fiber lines 114, etc. may result in severe and dire consequences, especially in instances where customers such as hospitals send and receive data via ONUs 116. Such risks and their potential consequences have led PON vendors and OLT manufacturers to be more willing to use standalone OTDRs and to incorporate OTDRs into OLTs, in spite of the related costs. In an attempt to offer comparable detection of issues such as bend 120 and fiber cuts, and in turn improve reliability over network system 100, techniques of this disclosure offer an alternative to the sole reliance on OTDRs. In particular, the techniques may enable ONUs 116 to generate and transmit an adapted DYING_GASP message when one or more of ONUs 116 detects a potential issue with corresponding line(s) of optical fiber lines 114.

In accordance with the techniques of this disclosure, ONUs 116 may utilize existing hardware, i.e., signal strength analyzers 122A-122N (“signal strength analyzers 122”) in this example, to provide for early detection of potential connectivity issues with an optical fiber by which an ONU and an OLT communicate, and communicate the potential issues before a complete loss of connectivity. As a result of utilizing existing hardware of ONUs 116 to detect the connectivity issues, the techniques may avoid incorporating expensive dedicated equipment, such as the above noted OTDR, at either OLT 102 or ONUs 116 to detect these types of connectivity issues. Each of ONUs 116 may implement the techniques to identify itself and/or the nature of the potential problem (e.g., permanently bent optical fiber, potential fiber cut in the immediate future, etc.). In some implementations, ONUs 116 may adapt messages defined in various PON standards, such as a so-called “DYING_GASP” message specified in a gigabit PON (GPON) standard, to alert OLT 102 of the potential issue. In response to this DYING_GASP message, OLT 102 may implement aspects of the techniques in this disclosure to trigger an alert that identifies one of ONUs 116 and/or the corresponding one of optical fiber lines 114 experiencing the issue. In this way, the techniques described in this disclosure may utilize existing ONU hardware to detect connectivity issues without increasing the complexity or cost of either OLTs or ONUs, thereby potentially promoting cost savings while providing a comparable level of issue detection as a dedicated OTDR (although often less accurate in identifying the location of the issue). While the techniques may not be as precise as an OTDR, the administrator may connect a stand-alone OTDR device to the identified fiber to more precisely identify the location of the bend or cut.

As shown in FIG. 1, ONUs 116 may include respective signal strength analyzers 122A-122N (collectively, “signal strength analyzers 122”). In various examples, signal strength analyzers may use, include, be, or be part of standard ONU hardware, i.e. hardware that is included in many ONUs currently available on the market to PON customers. Such standard ONU hardware has been shown, through various test results and research, to be sufficiently sensitive to detect issues with optical fiber link 110 and optical fiber lines 114, such as bend 120. Additionally, such standard ONU hardware is sufficiently sensitive to detect these issues at an early stage. Techniques of this disclosure may enable ONUs 116 to leverage these features of standard ONU hardware to generate and send a customized message upstream to OLT 102 before one or more of ONUs 116 lose connectivity due to the fiber issue. More specifically, ONUs 116 may implement the techniques to leverage these features of standard ONU hardware such that the customized message has a viable chance to reach OLT 102, thus enabling OLT 102 to alert a network administrator or other party equipped to rectify the fiber issue.

Signal strength analyzers 122 may be configured to determine or approximate the strength of optical signals received by ONUs 116 over respective optical fiber lines 114. Signal strength analyzers 122 may then compare the determined strength to a threshold value. In various implementations, signal strength analyzers 122 may determine a rate of signal strength degradation associated with a signal, and compare the rate of signal strength degradation to a rate threshold. For example, signal strength analyzers 122 may determine first and second signal strengths (e.g., at different instances of time) of a signal received via respective optical fiber lines 114. In this example, signal strength analyzers 122 may determine a degradation from the first signal strength to the second signal strength, and determine the rate of signal strength degradation as a function of the measure degradation over a predetermined period of time. Based on the comparison (e.g., of the rate of signal strength degradation to a rate threshold), signal strength analyzers 122 (and/or other components of ONUs 116) may detect a potential issue with respective optical fiber lines 114. Examples of such potential issues include signal quality degradation due to bends, an impending fiber cut (inferred from the rate, magnitude, or other characteristics of signal strength reduction), and others.

In the example of FIG. 1, bend 120 may cause a drop in signal strength along optical fiber line 114A. Bend 120 may be classified into one of two broad categories. The first category is commonly referred to as a “macrobend,” while the second category is commonly referred to as a “microbend.” Macrobends are often considered “tight” bends, and commonly entail a bend radius of one inch or less. As discussed, fiber-optic communications rely on the transmission light pulses over optical fiber lines. When an optical fiber line is bent, the bend tends to cause a phenomenon commonly known in optics as “refraction” of the transmitted light. Refraction alters various qualities of the transmitted light, resulting in signal degradation. Microbends, on the other hand, are more often associated with concentrated compression (e.g., pinching, squeezing, etc.) of the optical fiber. Microbends are commonly encountered when an optical fiber is not adequately sheathed (or “cladded”) to shield the optical fiber from concentrated compression. Similar to macrobends, microbends may create refraction within an optical fiber line, thereby causing signal degradation along the optical fiber line.

Due to the drop in signal strength caused by bend 120, both upstream communications sent by ONU 116A, as well as downstream communications received by ONU 116A, may suffer detrimental effects. Signal strength analyzer 122A may determine that the strength of a downstream optical signal received by ONU 116A is below a threshold value that indicates that optical fiber line 114A is free of potential issues. Based on the determination that the strength of the received optical signal is below the threshold, signal strength analyzer 122A may identify a potential issue with optical fiber line 114A. In the example of FIG. 1, bend 120 forms at least a portion of the potential issue with optical fiber line 114A.

Based on identifying the potential issue (hereinafter referred to as “bend 120 for ease of discussion), signal strength analyzer 122A may cause ONU 116A to send a message to OLT 102, notifying OLT 102 of bend 120. ONU 116A may send one or more messages (of various types, structures, and classifications) in order to notify OLT 102 of bend 120. In some implementations, ONU 116A may, in order to notify OLT 102 of bend 120, adapt a message that conforms to a structure and/or classification that is defined in the current GPON standard. For example, ONU 116A may adapt a message structure associated with a DYING_GASP message defined in the current GPON standard, and transmit the adapted message upstream to notify OLT 102 of bend 120. As discussed, ONUs, when experiencing power loss, may use DYING_GASP messages to notify OLTs of the power loss. Techniques of this disclosure may serve to enhance ONUs 116, enabling ONUs 116 to adapt the current GPON standard-defined DYING_GASP message structure to generate a message to notify OLT 102 of bend 120.

More specifically, signal strength analyzer 122A may utilize standard ONU hardware included in ONU 116A to detect a potential issue optical fiber line 114A before the issue causes ONU 116A to lose connectivity with OLT 102. As one illustrative example, signal strength analyzer 122A may, based on a rapid decline in signal strength experienced by ONU 116A, determine that bend 120 is a rapid bend. In turn, a rapid bend may indicate an impending fiber break, as might be caused by a backhoe or other equipment used for digging. In this example, ONU 116A may implement the techniques of this disclosure to generate and send a message expeditiously, thereby sending the message before optical fiber line 114A breaks or bend 120 compromises signal strength over optical fiber line 114A to a point where ONU 116A can no longer communicate over optical fiber line 114A. In this way, techniques of this disclosure may enable an ONU to send an indication of a potential issue with a fiber line, before the issue causes the ONU to lose connectivity over the PON.

In the example of FIG. 1, upon signal strength analyzer 122A determining that the strength of a received optical signal has dropped at a rate exceeding the rate threshold, ONU 116A may send a message that substantially conforms to the DYING_GASP structure defined in the current GPON standard (hereinafter, an “adapted DYING_GASP message”). Signal strength analyzer 122A may apply one or more factors in setting the rate threshold. For example, signal strength analyzer 122A may set the rate threshold sufficiently high so that signal ONU 116A does not generate a message for naturally-occurring signal strength attenuations. In other words, signal strength analyzer 122A may set the rate threshold sufficiently high to avoid false alarms, or false positives, in the context of detecting a potential issue with optical fiber line 114A. Conversely, signal strength analyzer 122A may set the threshold strength sufficiently low for ONU 116A to detect and react to issues with optical fiber line 114A early enough for ONU 116A to successfully communicate a message alerting OLT 102 to the potential issue. In this manner, signal strength analyzer may balance competing factors in setting the threshold strength.

More specifically, in some examples, a threshold value (e.g., the rate threshold described above) may be set such that ONU 116A determines the potential issue with optical fiber line 114A in enough time to enable ONU 116A to send the adapted DYING_GASP message to OLT 102 such that the adapted DYING_GASP message is successfully received by OLT 102 and not prevented from reaching OLT 102 due to the potential issue (e.g., bend 120) with optical fiber line 114A. Similarly, OLT 102 may receive the adapted DYING_GASP message from ONU 116A after ONU 116A detects the potential issue (e.g., bend 120) with optical fiber line 114A but prior to the potential issue preventing the adapted DYING_GASP message from being received by OLT 102.

ONU 116A may generate the adapted DYING_GASP message in a number of ways. In one example, ONU 116A may form the adapted DYING_GASP message such that the message exhibit a relatively terse structure. In the example of a terse message, ONU 116A may include minimal information in the adapted DYING_GASP message to notify OLT 102 of bend 120. For example, ONU 116A may include merely a notification that the strength of a received optical signal has dropped below the threshold value set by ONU 116A. Using a terse structure for the adapted DYING_GASP message may provide certain potential advantages. For example, by using a terse structure, ONU 116A may expend reduced or even minimal computing resources in forming an adapted DYING_GASP message. Additionally, an administrator or other operator of ONU 116A may need to implement reduced changes to the software running on ONU 116A to enable ONU 116A to generate and send the adapted DYING_GASP message. As another potential advantage, ONU 116A may expend minimal time in generating a terse version of an adapted DYING_GASP message, thereby enabling ONU 116A to send the adapted DYING_GASP message upstream before bend 120 causes ONU 116A to lose connectivity over optical fiber line 114A.

In other implementations, ONU 116A may cause the adapted DYING_GASP message to exhibit a more verbose structure. As one example, ONU 116A may generate the adapted DYING_GASP message to include specific information related to the diminished signal strength. For example, ONU 116A may include, in the adapted DYING_GASP message, one or more of the determined signal strength of the received optical signal, a drop level in the signal strength, a function of the drop level and a corresponding time for the drop (e.g., a rate of signal strength degradation), and others. Using a verbose structure for the adapted DYING_GASP message may provide certain potential advantages. As one example, OLT 102 may use the information included in the verbose message to generate a custom alert. Such a custom alert may, in turn, provide an administrator with information pertinent to bend 120 and/or other issues with optical fiber line 114A. As another example, OLT 102 may log the information included in the verbose message. By logging the information, OLT 102 may create a repository of historical issues with optical fiber line 114A and/or other connectivity issues experienced by ONU 116A. In this manner, techniques of this disclosure may enable an ONU to generate adapted DYING_GASP message to include varying levels of information, thereby providing advantages specific to each different level of information in the adapted DYING_GASP message. In turn, by including and/or logging various information pertinent to issues with optical fiber lines 114, ONUs 116 and OLT 102 may more effectively and efficiently transmit messages, trigger alerts, and enable network administrators to rectify the issue(s).

In still other implementations, ONU 116A may utilize a multiple message scheme to generate and send the adapted DYING_GASP message and associated information. In one such implementation, ONU 116A may send a primary message (e.g., an adapted DYING_GASP message having a terse structure) to notify OLT 102 of bend 120. At a time that is prior to, contemporaneous with, or subsequent to sending the primary message, ONU 116A may send a follow-up message that includes further information (e.g., information described with respect to verbose messages above, such as a rate of signal strength degradation) to OLT 102. In various implementations, the follow-up message may or may not be adapted from the DYING_GASP structure defined in the current GPON standard. In some instances where ONU 116A sends the follow-up message subsequent to sending the primary message, ONU 116A may store the follow-up message before sending. Although described with respect to a single primary message and a single follow-up message thus far, ONU 116A may implement the techniques of this disclosure to send several follow-up messages associated with a single primary message to notify OLT 102 of bend 120 and other information related to issues with optical fiber line 114A. By generating and sending adapted DYING_GASP messages of varying structures in the manner described, ONU 116A may begin by sending a message to OLT 102 before bend 120 or a resulting fiber break causes ONU 116A to lose connectivity. Owing to the terse structure of the primary message, ONU 116A may send this initial message as expeditiously as possible. Connectivity permitting, ONU 116A may send the secondary message, thus providing OLT 102 with more information regarding bending 120, and thereby enabling OLT 102 to generate a more robust alert. In this manner, techniques of this disclosure may leverage varying message structures to more efficiently and effectively manage time resources that may be limited by issues experienced by optical fiber lines.

In some implementations, ONU 116A may generate several identical or similar messages and store (e.g., to cache memory) the messages. This process is also referred to herein as “caching” the messages. ONU 116A may then transmit the cached messages upstream at various time intervals. For example, based on signal strength analyzer 122A detecting bend 120, ONU 116A may cache several adapted DYING_GASP messages for future transmission to OLT 102. The cached adapted DYING_GASP messages may be terse, verbose, or any combination thereof. ONU 116A may then send the cached adapted DYING_GASP messages to OLT 102 at various time intervals. In one example, ONU 116A may send the cached adapted DYING_GASP messages at periodic intervals, i.e., ONU 116A may use a predetermined time delay between transmissions of any two consecutive cached messages. In another example, ONU 116A may vary the time delays between transmissions of consecutive cached messages. ONU 116A may determine the varied time delays based on several criteria, including severity of the drop in received signal strength, past heuristics related to administrator response time, physical distance to OLT 102 and/or an administrator's location, historical data pertaining to lost upstream transmissions, and others.

Additionally, ONU 116A may implement the techniques of this disclosure to cache different sets of messages. For example, ONU 116A may cache a first set of adapted DYING_GASP messages in response to a first drop in signal strength determined by signal strength analyzer 122A. ONU 116A may then cache a second set of adapted DYING_GASP messages in response to a second drop in received signal strength determined by signal strength analyzer 122A. Optionally, ONU 116A may discard some or all unsent cached messages belonging to the first set, based on signal strength analyzer 122A detecting the second drop in received signal strength. For example, the first set may include verbose messages that include information specific to the first drop in received signal strength. ONU 116A may discard these verbose messages, while preserving any unsent terse messages (as the terse messages may be sufficiently generic to apply to the second drop in received signal strength). In this manner, techniques of this disclosure may enable an ONU to cache and transmit multiple adapted DYING_GASP messages to notify an OLT of one or more issues with an optical fiber through which the ONU communicates with the OLT.

As shown in FIG. 1, OLT 102 may include alert generator 106. Optionally, OLT 102 may include optical time domain reflectometer (OTDR) 108. The optional nature of OTDR 108 is illustrated by dashed-line borders. Alert generator 106 may be operable to generate (or “trigger”) one or more alerts in response to OLT 102 receiving an adapted DYING_GASP message from any of ONUs 116. In an example where OLT 102 receives an adapted DYING_GASP message from ONU 116A, alert generator 106 may generate an alert identifying ONU 116A and/or corresponding optical fiber line 114A as experiencing an issue. Additionally, alert generator 106 may cause OLT 102 to transmit the generated alert(s). In one example, alert generator 106 may cause OLT 102 transmit an alert over service provider network 104 and/or downstream to the remainder of ONUs 116. For example, OLT 102 may transmit the alert to one or more parties (e.g., network administrators, etc.) who may be in a position to rectify bend 120 and other issues that may be related to the adapted DYING_GASP message. As with ONUs 116, alert generator 106 may generate varying types of alerts, as well as multiple alerts which may be cached and sent at various intervals.

In some implementations, alert generator 106 may generate the alert(s) based on a combination of conditions. For example, in addition to receiving an adapted DYING_GASP message from ONUs 116, alert generator 106 may require a loss of communication between OLT 102 and the sending one of ONUs 116. In the instance of FIG. 1, OLT 102 may receive an adapted DYING_GASP message from ONU 116A. The received adapted DYING_GASP message may satisfy a first condition required for alert generator 106 to trigger an alert. To check for a second condition required for alert generator 106 to trigger the alert, alert generator 106 may cause OLT 102 (or components thereof) to check for connectivity with ONU 116A. For example, OLT 102 may poll ONU 116A (e.g., by packaging a signature in a downstream communication). In another example, OLT 102 may monitor all received upstream transmissions (in the form of PON frames) for communications sent by ONU 116A. If OLT 102 is unable to communicate with ONU 116A after a predetermined number of attempts or threshold period of time, alert generator 106 may trigger an alert pertaining to ONU 116A. Implementations in which alert generator 106 requires multiple conditions (e.g., a received adapted DYING_GASP message as well as a loss of connectivity with the sending ONU) may provide certain advantages. As one example, OLT 102 may only send alerts when optical fiber line 114A is affected by a real issue. In other words, alert generator 106 may be robust, by avoiding triggering alerts in instances where the received adapted DYING_GASP message may constitute a false alarm (temporary drop of signal strength, etc.).

Though described with respect to a loss of connectivity for ease of discussion, alert generator 106 may use a number of different criteria to determine whether the second condition is satisfied. For example, alert generator 106 may determine that the second condition is met when communications received from ONU 116A are below a threshold signal strength. In various such examples, OLT 102 may monitor, for a predetermined time period, all communications received from ONU 116A. If the communications are below the threshold signal strength over the predetermined time period, alert generator 106 may trigger the alert. In this manner, an OLT may implement the techniques of this disclosure in a number of ways to generate an alert in response to receiving an adapted DYING_GASP message from a downstream ONU.

As discussed, OLT 102 may, in some implementations, include optical time domain reflectometer (OTDR) 108. OTDR 108 may be operable to detect bends, breaks, and other issues with optical fiber lines 110 and 114. To detect such issues, OTDR 108 may first inject one or more optical pulses into optical fiber 110 (and thereby, into optical fiber lines 114). Next, OTDR 108 may receive a return pulse associated with the injected pulse. The return pulse may be a reflection caused by a bend in one or more of optical fiber lines 110 and 114 (a phenomenon commonly known as “Rayleigh Backscatter”). Based on various properties of the return pulse, OTDR 108 may discern or estimate the location and/or nature of issues with optical fiber lines 110 and 114. For example, OTDR 108 may measure the time that elapses between injecting the optical pulse and receiving the reflection. Based on the elapsed time, OTDR 108 may determine an approximate location of bend 120. In scenarios where optical fiber 114A has broken, OTDR 108 may determine an approximate break location of optical fiber 114A.

In the example of FIG. 1, OLT 102 may receive an adapted DYING_GASP message from ONU 116A, and then use OTDR 108 to identify the cause of received adapted DYING_GASP message. In this example, OTDR 108 may discern one or more of the location, severity, and other properties of bend 120. Alert generator 106 may then generate an alert that includes some or all of the information that OTDR 108 gathered with respect to bend 120. In some examples, alert generator 106 may generate multiple alerts, with each generated alert including portions of the gathered information relating to bend 120. By including information related to bend 120 in the generated alert(s), alert generator 106 may implement the techniques of this disclosure to provide certain advantages. For example, by including a location (or even an approximate location) of bend 120 in an alert, alert generator 106 may save a network administrator the time needed to search for bend 120 before implementing remedial measures.

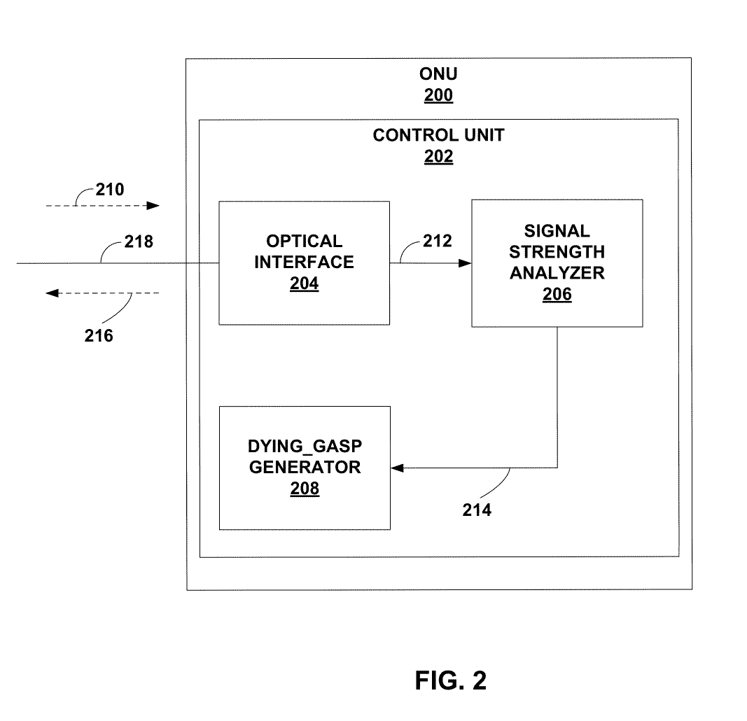

FIG. 2 is a block diagram illustrating an example ONU 200 that detects a potential issue with an optical fiber 218 to which ONU 200 is connected, and communicates the issue upstream using an adapted DYING_GASP message 216, in accordance with one or more aspects of this disclosure. ONU 200 includes a control unit 202. Control unit 202, in turn, includes optical interface 204, signal strength analyzer 206, and DYING_GASP generator 208. ONU 200 connects to optical fiber 218 to communicate with upstream optical network devices, such as OLT 102 described with respect to FIG. 1. ONU 200 is an example implementation of one or more of ONUs 116 described with respect to FIG. 1.

Control unit 202 may, in various examples, comprise any combination of one or more processors, one or more field programmable gate arrays (FPGAs), one or more application specific integrated circuits (ASICs), and one or more application specific standard products (ASSPs). Control unit 202 may also comprise memory, both static (e.g., hard drives or magnetic drives, optical drives, FLASH memory, EPROM, EEPROM, etc.) and dynamic (e.g., RAM, DRAM, SRAM, etc.), or any other non-transitory computer readable storage medium capable of storing instructions that cause the one or more processors to perform the efficient network management techniques described in this disclosure. Thus, control unit 202 may represent hardware or a combination of hardware and software to support the below described components, modules or elements, and the techniques should not be strictly limited to any particular example described below.

As shown in FIG. 2, ONU 200 may use optical interface 204 to receive downstream communications (e.g., in the form of PON frames 210) over optical fiber 218. More information concerning PON frames can be found in the GPON standard (ITU-T G984), published by the International Telecommunication Union Telecommunication Standardization Sector, which is hereby incorporated by reference as if set forth in its entirety. In some implementations, optical interface 204 may be configured to relay PON frames 210 (or information related to PON frames 210) to signal strength analyzer 206. One illustrative example of information that optical interface 204 may relay to signal strength analyzer 206 is received signal strength indication (RSSI) 212. RSSI 212 may include a measure or estimate of the strength of each respective frame of PON frames 210. RSSI measurements, such as RSSI 212 of FIG. 2, may be used for operations common to the GPON standard. Examples of such operations include ranging (i.e., measurement of a logical distance between the OLT and an ONU) and other operations used in a PON to assign time slots for upstream transmissions, such that upstream transmissions from multiple ONUs do not collide before reaching the OLT. In this way, techniques of this disclosure may leverage data collected by currently available, standard ONU hardware, and repurpose such data for the generation and transmission of adapted DYING_GASP messages to indicate potential issues with an optical fiber line.

Based on RSSI 212, signal strength analyzer 206 may detect a potential issue with optical fiber 218. For example, signal strength analyzer 206 may compare RSSI 212 to a threshold. Signal strength analyzer 206 and/or other components of ONU 200 may set the threshold based on RSSI values associated with an issue-free optical fiber (e.g., optical fiber line 114N of FIG. 1) or an optical fiber that includes a maximum acceptable bend level. If signal strength analyzer 206 determines that RSSI 212 is below the threshold, signal strength analyzer 206 may generate drop notification 214 and send drop notification 214 to DYING_GASP generator 208.

In various implementations, signal strength analyzer 206 may determine a rate of signal strength degradation of an optical signal received via optical fiber 218. For example, signal strength analyzer 206 may determine a first signal strength and a second signal strength of the received signal by determining RSSI 212 at different instances of time. Additionally, signal strength analyzer 206 may measure a difference (or degradation) from the first to the second signal strength, and calculate a function that measures the degradation per unit time. For example, signal strength analyzer may use a predetermined time period as the time unit (or a factor/multiple thereof) against which to measure the signal strength degradation. In turn, signal strength analyzer 206 may compare the rate of signal strength degradation to a rate threshold, and, based on the comparison, generate and send drop notification 218 to DYING_GASP generator 208. For example, if signal strength analyzer 206 determines that the rate of signal strength degradation is greater than the rate threshold, signal strength analyzer may generate and send drop notification 218 to DYING_GASP generator 208. In one implementation, signal strength analyzer 206 may set the threshold based on a degradation of 0.6 decibels within a period of 100 milliseconds.

In some examples, signal strength analyzer 206 may implement more enhanced techniques of this disclosure in determining whether to generate and send drop notification 214. In one such example, signal strength analyzer 206 may determine the degradation of RSSI 212 as measured over time. More specifically, signal strength analyzer 206 may determine the values of multiple instances of RSSI 212 for respective PON frames 210. Signal strength analyzer 206 may then determine the degradation of RSSI 212 over a predetermined time period. If signal strength analyzer 206 that the degradation of RSSI 212 over the predetermined time period constitutes a “precipitous drop” in signal strength, signal strength analyzer 206 may generate drop notification 214 based on the perceived precipitous drop.

As discussed, control unit 202 may include various types of storage devices (not shown in FIG. 2 for ease of illustration purposes). In some examples, signal strength analyzer may store information related to the degradation of RSSI 212 to one or more storage device provided by control unit 202. For example, in an implementation in which signal strength analyzer 206 generates drop notice 214 based on signal strength degradation as measured over time, signal strength analyzer 206 may store historical data related to past signal strength degradations and the corresponding time periods. Other examples of historical data that signal strength analyzer 206 may store include correlations between signal degradation and fiber cuts, time elapsed before the potential issue with optical fiber 218 was rectified, seasonal tendencies of bends and breaks, and others.

As discussed, signal strength analyzer 206 may set the threshold based on various criteria. Additionally, signal strength analyzer 206 may set the threshold based on one or more goals contemplated in the techniques of this disclosure. One such goal may be to cause ONU 200 to generate and send an adapted DYING_GASP message in as many instances of possible when optical fiber 218 exhibits a potential issue, while not allowing the adapted DYING_GASP messages to consume excessive levels of bandwidth afforded by optical fiber 218 and any other optical fiber links that are upstream of ONU 200. To achieve this goal, signal strength analyzer 206 may set the threshold to be sensitive (e.g., low) enough to trigger an adapted DYING_GASP message when optical fiber 218 exhibits a discernible potential issue, but not so sensitive as to trigger an adapted DYING_GASP message in instances of expected signal strength attenuation. In this manner, ONU 200 (and components thereof) may implement the techniques of this disclosure in a robust way, while not wasting available bandwidth over the network.

DYING_GASP generator 208 may receive drop notification 214 from signal strength analyzer 206, and in response, may generate adapted DYING_GASP message 216. As described, adapted DYING_GASP message 216 may substantially conform to the DYING_GASP message structure specified in the current GPON standard, with certain variants. For example, DYING_GASP generator 208 may adapt the DYING_GASP structure to include a notification that one or more of PON frames 210 exhibits a signal strength that is below a threshold (whether measured purely by signal strength, strength degradation as measured over time, etc.). Additionally, DYING_GASP generator 208 may include other information in adapted DYING_GASP message 216, such as the latest value of RSSI 212, the amount by which RSSI 212 has dropped over two or more of PON frames 210, a rate of drop in RSSI 212 as measured over time, etc.

In some implementations, DYING_GASP generator 208 may use a message template to generate adapted DYING_GASP message 216. For example, DYING_GASP generator 208 may adapt the GPON standard-specified DYING_GASP structure to include (and/or omit) certain data. Then, when prompted by drop notification 214, DYING_GASP generator 208 may generate adapted DYING_GASP message 216 using the template. In some instances, DYING_GASP generator 208 may populate all the fields provided in the message template. Examples of such fields include a drop level exhibited by RSSI 212, the rate of signal strength degradation as measured over time, and others. In some instances, the message template may include a signature field, which DYING_GASP generator 208 may populate in order to include information specific to ONU 200 in adapted DYING_GASP message 216.

DYING_GASP generator 208 may populate the message template differently in different scenarios. For example, DYING_GASP generator 208 may generate a first instance of adapted DYING_GASP message 216 as a terse message, such as by populating only a minimal number of fields in the message template (and leaving the other fields blank and/or with their default values). DYING_GASP generator 208 may then generate a subsequent instance of adapted DYING_GASP message 216 as a more verbose message, populating one more additional fields of the message template. DYING_GASP generator 208 may then generate a third instance of adapted DYING_GASP message 216 as a most verbose possible message, populating all fields provided in the message template. In this manner, techniques of this disclosure may enable DYING_GASP generator 208 to use a message template in different ways, suiting different scenarios, administrator demands, and information availability on a case-by-case basis.

In some examples, DYING_GASP generator 208 and/or other components of ONU 200 may set a time limit by which to send adapted DYING_GASP message 216 upstream. The time limit may be measured from the time that DYING_GASP generator 208 first generates adapted DYING_GASP message 216. In such example, the time limit may be set to 1 millisecond. Setting a time limit may be useful in several scenarios addressed by the techniques of this disclosure. For example, a precipitous drop in RSSI 212 may indicate a rapid bend in optical fiber 218. A rapid bend, in turn, may be indicative of an impending break of optical fiber 218, owing to the relatively poor malleability of optical fibers in general. In such a scenario, ONU 200 may need to send adapted DYING_GASP message 216 as quickly as possible, to avoid delaying until after optical fiber 218 breaks. As a result, ONU 200 may use a relatively low time limit, such as 1 millisecond, to ensure that adapted DYING_GASP message 216 is successfully sent to the upstream optical device.

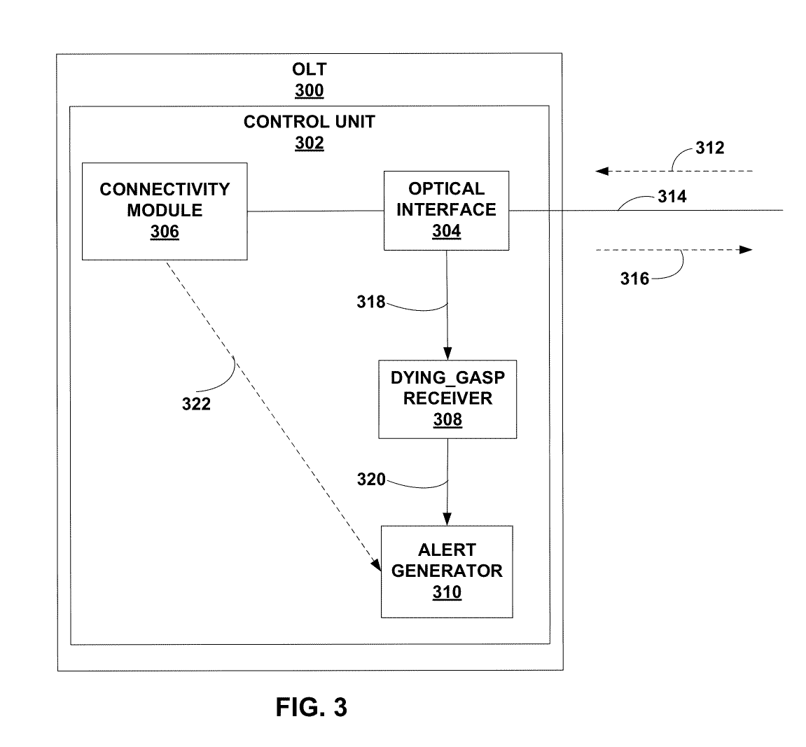

FIG. 3 is a block diagram illustrating OLT 300 that receives upstream communication 312 including adapted DYING_GASP message 318 from an ONU indicating an issue with an optical fiber, determines connectivity to the ONU that sent the message, and generates alert 316 based on adapted DYING_GASP message 318 and the determined connectivity, in accordance with one or more aspects of this disclosure. OLT 300 includes control unit 302. Control unit 302, in turn, includes optical interface 304, connectivity module 306, DYING_GASP receiver 308, and alert generator 310.

Control unit 302 may, in various examples, comprise any combination of one or more processors, one or more field programmable gate arrays (FPGAs), one or more application specific integrated circuits (ASICs), and one or more application specific standard products (ASSPs). Control unit 302 may also comprise memory, both static (e.g., hard drives or magnetic drives, optical drives, FLASH memory, EPROM, EEPROM, etc.) and dynamic (e.g., RAM, DRAM, SRAM, etc.), or any other non-transitory computer readable storage medium capable of storing instructions that cause the one or more processors to perform the efficient network management techniques described in this disclosure. Thus, control unit 302 may represent hardware or a combination of hardware and software to support the below described components, modules or elements, and the techniques should not be strictly limited to any particular example described below.

OLT 300 may connect to optical fiber 314 to communicate with downstream optical network devices, such as ONU 200 described with respect to FIG. 2. As described with respect to FIG. 1, optical fiber 314 may connect to an optical splitter, an optical combiner, or an optical network device that combines the functionalities of a splitter and a combiner, in order to communicate with downstream ONUs. The optical splitter and/or combiner may then connect to each ONU by a separate optical fiber link. Though described thus far with respect to potential issues with the separate optical fiber links, FIG. 3 will be described with respect to potential issues with optical fiber 314 (that is directly connected to OLT 300) to illustrate another scenario in which techniques of this disclosure may prove useful.

OLT 300 may receive, using optical interface 304, upstream communication 312 (in the form of PON frames) from one or more ONUs. Upstream communication 312 may include adapted DYING_GASP message 318, to indicate a potential issue with optical fiber 314. A potential issue with optical fiber 314 may cause signal strength degradation to several ONUs, because downstream traffic over optical fiber 314 is distributed to all ONUs in the optical network. As a result, a potential issue with optical fiber 314 may cause several ONUs to generate and send adapted DYING_GASP messages to OLT 300. Although a potential issue with optical fiber 314 may cause upstream communication 312 to include several adapted DYING_GASP messages, FIG. 3 will be described with respect to a single adapted DYING_GASP message 318, for ease of discussion.

DYING_GASP receiver 308 may detect adapted DYING_GASP message 318 in upstream communication 312. In some examples, DYING_GASP receiver 308 may extract adapted DYING_GASP message 318 from upstream communication 312, and optionally store adapted DYING_GASP message 318 (or portions thereof) to various storage and/or memory devices that are accessible to OLT 300. In examples where adapted DYING_GASP message 318 is verbose, DYING_GASP receiver 308 may store historical data related to potential issues with 314. In this manner, DYING_GASP receiver 308 may implement techniques of this disclosure to enable parties, such as network administrators, to discern tendencies and patterns related to past issues with optical fiber 314.

In some implementations, OLT 300 may use connectivity module 306 to determine whether or not OLT 300 is able to communicate with the ONU that sent adapted DYING_GASP message 318. Connectivity module 306 may determine the ability to communicate at various time intervals after DYING_GASP receiver 308 receives adapted DYING_GASP message 318. For example, if adapted DYING_GASP message 318 includes information indicating a rapid drop in signal strength, connectivity module 306 may determine connectivity with the ONU shortly (e.g., 1 second) after receiving adapted DYING_GASP message 318. As discussed, the rapid drop in signal strength may indicate an impending break in optical fiber 314. On the other hand, if adapted DYING_GASP message 318 includes information indicating a gradual drop in signal strength, connectivity module 306 may determine the connectivity at a relatively later time (e.g., 30 seconds) after receiving adapted DYING_GASP message 318. A gradual drop in signal strength may indicate a slow bend in optical 314, which may result in a break at a later time, or perhaps no threat at all of a break. If connectivity module 306 determines that OLT 300 is unable to communicate with the ONU, connectivity module 306 may send disconnect notification 322 to alert generator 308.

Connectivity module 306 may determine the ability of OLT 300 to communicate with a sending ONU in a number of ways. For example, in accordance with the current GPON standard, an ONU that does not have data to communicate upstream may send so-called “idle messages” to OLT 300. Connectivity module 306 may monitor upstream communication 312 for idle messages from an ONU that sent adapted DYING_GASP message 318. In this example, if connectivity module 306 does not receive an idle message from the sending ONU for a predetermined period of time, connectivity module 306 may determine that OLT 300 is unable to communicate with the ONU that sent adapted DYING_GASP message 318.

Another way in which connectivity module 306 may determine the ability of OLT 300 to communicate with an ONU is based on concept commonly known as “polling.” In this example, connectivity module 306 may inquire, or “poll,” the ONU to solicit a number of backlog of transmissions from the ONU. More specifically, an ONU may maintain a backlog value, because the ONU may not always be able to send all of its upstream transmissions in a single allotted time slice. If the ONU has no pending upstream transmissions, the ONU may maintain a zero value to denote the backlog. By polling the ONU for the backlog value, connectivity module 306 may not only determine the amount of pending traffic from the ONU, but may determine whether OLT 300 is able to communicate with the ONU at all.

Based on receiving adapted DYING_GASP message 318, DYING_GASP receiver 308 may send instruction 320 to alert generator 310. In some examples, DYING_GASP receiver may send instruction 320 based on parameters related to DYING_GASP message 318. In one example, DYING_GASP receiver 308 may generate instruction 320 based on the rate of signal strength degradation indicated by adapted DYING_GASP message 318. In other examples, DYING_GASP receiver 308 may require a combination of conditions to generate instruction 320. For instance, DYING_GASP receiver 308 may require, in addition to receiving adapted DYING_GASP message 318, that OLT 300 is unable to communicate with the sending ONU. In this instance, DYING_GASP receiver 308 may receive notification 320 from connectivity module 306 that OLT 300 is unable to communicate with the ONU that sent adapted DYING_GASP message 318.

Upon receiving instruction 320, alert generator 310 may generate alert 316. Alert generator may then send alert 316 over a variety of communicative connections available to OLT 300. In the example of FIG. 3, alert generator 310 sends alert 316 over optical fiber 314, thereby broadcasting alert 316 downstream to all ONUs that are currently able to communicate with OLT 300. In this example, alert generator 310 may use the optical network to communicate with a party, such as a network administrator, who may be in a position to rectify the issue with optical fiber 314.

In the specific implementation of FIG. 3, as well as other example implementations, alert generator 310 may send alert 316 over a different communication channel from optical fiber 314. For example, alert generator 310 may send alert 316 upstream (e.g., over service provider network 104 illustrated in FIG. 1). In other examples, alert generator 310 may send copies of alert 316 over multiple communication channels, including any communication channel described above. In this manner, alert generator 310 may implement techniques of this disclosure to disseminate alert 316 to various recipients, thereby prompting timely rectification of any issues with optical fiber 314.

Similarly to adapted DYING_GASP messages described herein, alert 316 may include various amounts and/or types of information. For example, if alert generator 310 generates alert 316 to exhibit a terse structure, alert 316 may include minimal information related to the issue with optical fiber 314 (e.g., simply that the issue exists). In an example where alert 316 is more verbose, alert 316 may include information identifying the ONU that sent adapted DYING_GASP message 318. In a more verbose example still, alert 316 may include an approximate break location determined by an OTDR (not shown for ease of illustration purposes only). In this manner, alert generator 310 may implement techniques of this disclosure to include varying amounts and types of information in alert 316, thereby enabling customized efforts to rectify issues with optical fiber 314 as quickly as possible.

As described with respect to FIG. 1, OLT 300 may include an optical time domain reflectometer (not shown in FIG. 3 for ease of illustration purposes only). In other examples, OLT 300 may be communicatively coupled to an OTDR. In still other examples, alert generator 310 may include, in alert 316, an instruction to a recipient (e.g., a network administrator) to connect an OTDR to, or in place of, OLT 300, to estimate the location of the potential issue with optical fiber 314. By additionally estimating the location of the potential issue with optical fiber 314 using an OTDR, techniques of this disclosure may assist in a more timely rectification of the potential issue with optical fiber 314.

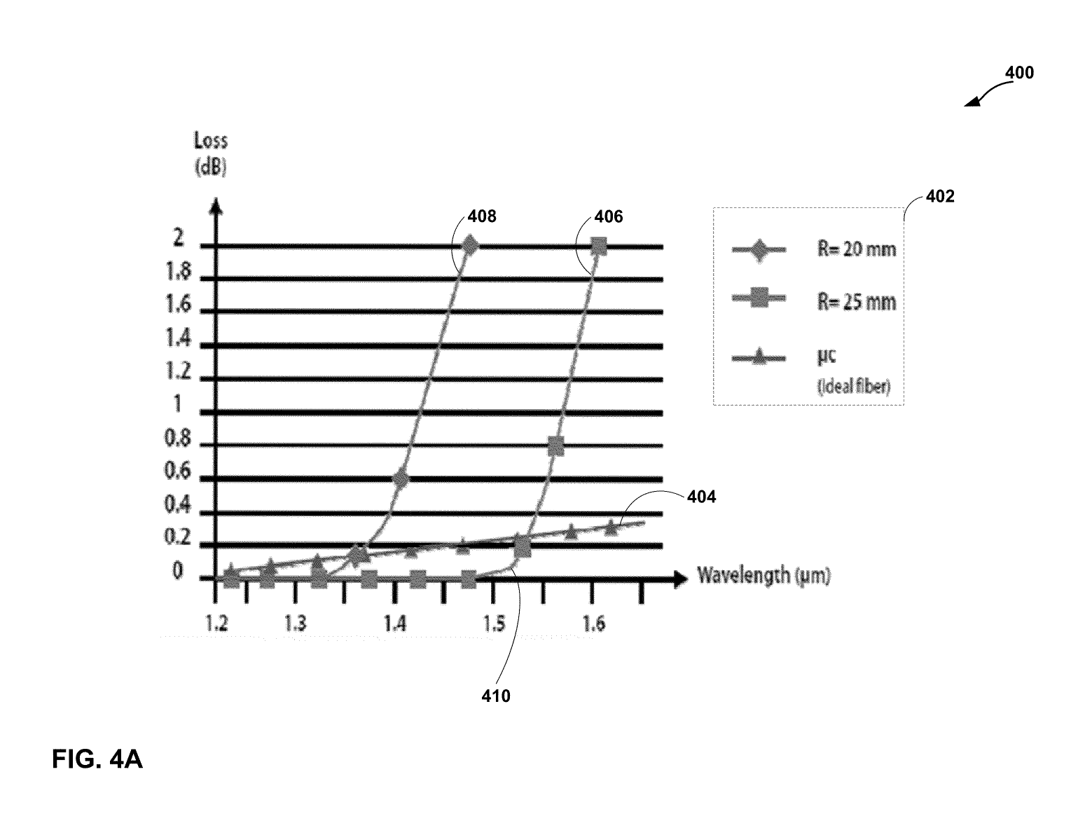

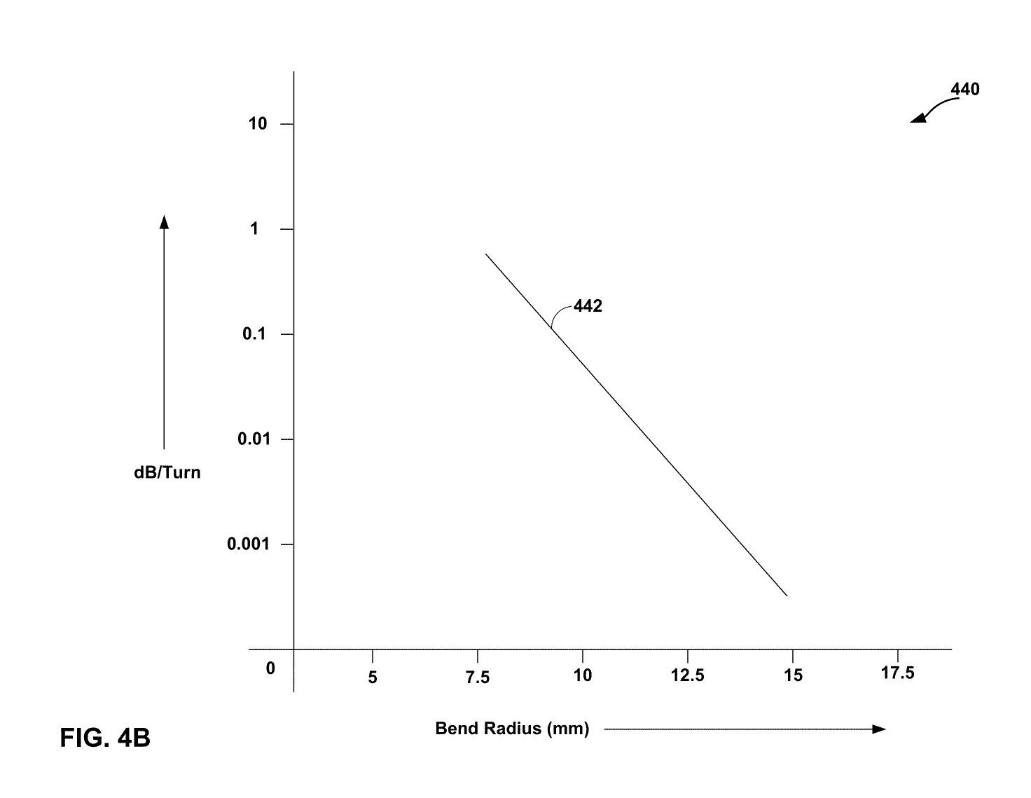

FIG. 4A is a graph illustrating signal degradation in an optical fiber caused by bending of the optical fiber. Graph 400 includes three plots, namely, plots associated with no-bend 404, intermediate-bend 406, and sharp-bend 408. The x-axis (horizontal axis) of graph 400 corresponds to wavelength values (in micrometers) of light pulses transmitted across an optical fiber. The y-axis (vertical axis) of graph 400 corresponds to a loss of signal strength (in decibels). As shown, a lower value bend radius is indicative of a sharper bend (or, in other words, bend radius may be inversely proportional to the sharpness of the resulting bend in the optical fiber).

As listed in legend 402, no-bend 404 is associated with what may be considered an “ideal fiber.” In other words, the optimum performance of an optical fiber, in terms of signal strength loss across different wavelengths of transmitted light pulses, may be represented by no-bend 404. As shown by the gradual slope of no-bend 404, the optical fiber of no-bend 404 experiences a steady, yet small loss of signal strength with increasing wavelength of the transmitted light pulse. More specifically, no-bend 404 illustrates an optical fiber that loses under 0.4 decibels of signal strength over a wavelength increase of approximately 0.45 micrometers. Additionally, the steady slope of no-bend 404 indicates that the loss of signal strength may be considered predictable, and that the loss of signal does not exceed the sub-0.4 decibel level within the illustrated wavelength range.

In contrast, intermediate-bend 406 illustrates an optical fiber that includes a bend having a radius of 25 millimeters (as shown in legend 402). As shown by the slope of intermediate-bend 406, the corresponding optical fiber experiences no discernible loss of signal strength for transmissions of wavelengths ranging from 1.2 to approximately 1.475 micrometers (i.e., a range of approximately 0.325 micrometers). However, beginning at a wavelength of approximately 1.475 micrometers, the optical fiber of intermediate-bend 406 experiences a sharp drop in signal strength with increasing wavelengths of transmitted light pulses. More specifically, intermediate-bend 406 exhibits a signal strength drop of 2 decibels over a wavelength increase of approximately 0.125 micrometers.

Sharp-bend 408 illustrates an optical fiber that includes a bend having a radius of 20 millimeters, as shown in legend 402. Similarly to intermediate-bend 406, sharp-bend 408 exhibits no discernible drop in signal strength for an initial wavelength range, followed by a steep drop in signal strength over a subsequent wavelength range. More specifically, the optical fiber of sharp-bend 408 does not lose a discernible amount of signal strength in a wavelength range running from 1.2 micrometers to approximately 1.325 micrometers. However, starting at a wavelength of approximately 1.325 micrometers, the optical fiber of sharp-bend 408 loses 2 decibels of signal strength over a wavelength increase of approximately 0.11 micrometers (a steeper loss than the 2 decibel loss exhibited by intermediate-bend 406).

Moreover, the signal strength drop experienced by the optical fiber of intermediate-bend 406 includes a steep drop at a wavelength of approximately 1.52 micrometers (a point called out by elbow 410). The steep drop illustrated by elbow 410 highlights the susceptibility of higher wavelength (e.g., a wavelength of approximately 1490 nanometers) optical signals to signal attenuation caused by fiber bends. More specifically, at wavelengths of approximately 1.52 micrometers and greater, an optical signal may experience a rapid drop in signal strength due to fiber bends of lesser sharpness (e.g., intermediate-bend 406 is not as sharp as sharp-bend 408). To summarize, in scenarios where an optical fiber carries signals of a greater wavelength, the reliability of the optical fiber is compromised by less severe bends. As a result, implementing techniques of this disclosure may enable a more reliable use of optical fibers for transport of signals across various wavelengths.

FIG. 4B is a graph 440 illustrating signal strength degradation over fiber bends of varying levels of sharpness. Graph 440 may illustrate, approximately, a rate of signal strength degradation of an optical fiber as the optical fiber carries an optical signal having a wavelength of 1.55 micrometers (alternatively, 1550 nanometers). Graph 440 illustrates the signal degradation in terms of decibels per turn (a single instance of a bend) on the y-axis and the corresponding bend radius on the x-axis. As shown by curve 442, the signal strength exhibits a more severe degradation at a sharper bend (e.g., of radius 7.5 mm) than at bend of lesser sharpness (e.g., of radius 15 mm). Also, as shown by curve 442, the signal strength exhibits a rapid drop (e.g., of almost 1 decibel) as a single bend transitions from a radius of 15 mm to 7.5 mm. In situations where a fiber optic line encounters multiple bends (e.g., with lines that are deployed over a long distance), the signal strength may degrade even more severely. Graph 440 may represent the signal strength degradation of an optical signal having a wavelength of approximately 1550 nanometers, and variations may occur over different classes, grades, or types of optical fiber lines.

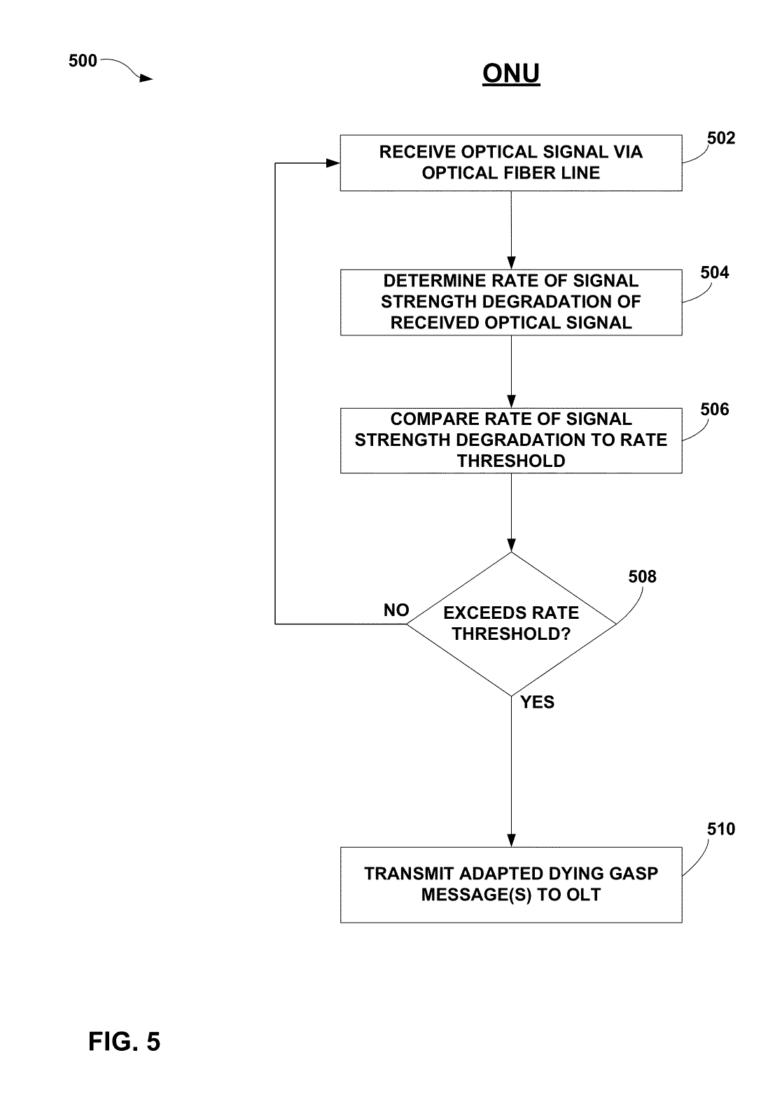

FIG. 5 is a flowchart illustrating an example process 500 by which an ONU may implement the techniques of this disclosure to detect an issue with an optical fiber and communicate the issue upstream using an adapted DYING_GASP message. While process 500 may be performed by any ONU described in the present disclosure, process 500 is described herein with reference to ONU 200 of FIG. 2 for ease of discussion.

Process 500 may begin when ONU 200 receives, using optical interface 204, an optical signal via optical fiber line 218 (step 502). As described, the received optical signal may include downstream communications (e.g., in the form of PON frames 210). ONU 200 may then use signal strength analyzer 206 to determine a rate of signal strength degradation of the received optical signal (step 504). As discussed, signal strength analyzer 206 may determine the rate of signal strength degradation in a variety of ways, such as by determining the received signal strength indication (RSSI) 212 of the received optical signal at different instances, and calculating a drop in signal strength per unit time. Signal strength analyzer 206 may then compare the determined rate of signal strength degradation to a rate threshold (step 506). In various implementations, signal strength analyzer 206 may set the rate threshold at different values, based on various criteria.

ONU 200 may then implement different steps based on whether or not the rate of signal strength degradation exceeds the rate threshold (decision block 508). If signal strength analyzer 206 determines that the rate of signal strength degradation does not exceed the rate threshold (e.g., the signal strength has not diminished, any drop in signal strength is not rapid enough to exceed the rate threshold, etc.), ONU 200 may simply continue to receive downstream communications over optical fiber 218 (effectively looping back to step 502). On the other hand, if signal strength analyzer 206 determines that the rate of signal strength degradation exceeds the rate threshold, ONU 200 may transmit one or more adapted DYING_GASP messages 216 over optical fiber 218 (step 510). In the specific example of ONU 200, DYING_GASP generator 208 may generate one or more adapted DYING_GASP messages 216 for immediate or future upstream transmission (e.g., to OLT 300 of FIG. 3). In other implementations in accordance with techniques of this disclosure, functionalities described with respect to components of ONU 200 may be combined and/or further delegated between other optional modules of control unit 202.

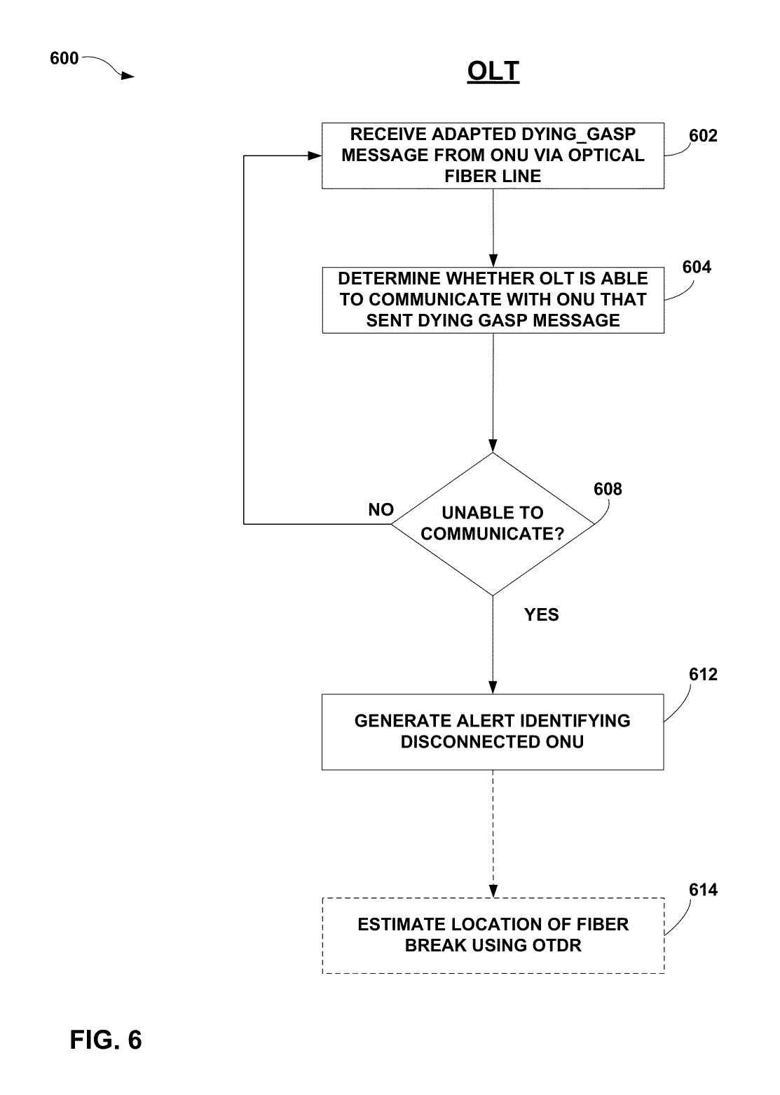

FIG. 6 is a flowchart illustrating an example process 600 by which an example OLT may implement the techniques of this disclosure to receive an adapted DYING_GASP message from an ONU to indicate an issue with an optical fiber, determine whether the OLT is able to communicate with the ONU, and generate an alert based on the received message and the determination. While process 600 may be performed by any OLT described in the present disclosure, process 600 is described herein with reference to ONU 300 of FIG. 3 for ease of discussion.

Process 600 may begin when OLT 300 receives, via optical fiber 314, upstream communication 312 that adapted DYING_GASP message 318 (step 602). In the particular example of process 600, OLT 300 may require both adapted DYING_GASP message 318 and subsequent inability to communicate with the sending ONU before generating an alert. In other examples, OLT 300 may not require the subsequent inability to communicate with the sending ONU, or may optionally check for ability to communicate with the sending ONU on a case-by-case basis.

To fulfill the second requirement described above, connectivity module 306 may determine whether OLT 300 is able to communicate with the ONU that sent adapted DYING_GASP message 318 (step 604). OLT 300 may implement varying steps based on whether OLT 300 is able to communicate with the sending ONU (decision block 608). If OLT 300 is able to communicate with the sending ONU, OLT 300 may continue to receive upstream communication 312 via optical fiber 314 (effectively looping back to step 602). On the other hand, if OLT 300 is unable to communicate with the sending ONU, OLT 300 (or components thereof) may perform one or more operations.

For example, alert generator 310 may generate alert 316 identifying the disconnected ONU (step 612). As discussed, alert generator 310 may include other information in alert 316, apart from merely identification of the disconnected ONU. OLT 300 may optionally estimate the location of the fiber break using an OTDR (if OLT 300 is equipped with an OTDR, by soliciting an administrator to connect an OTDR, etc.) (step 614). Step 614 is illustrated using a dashed line border, to indicate that step 614 is optional.

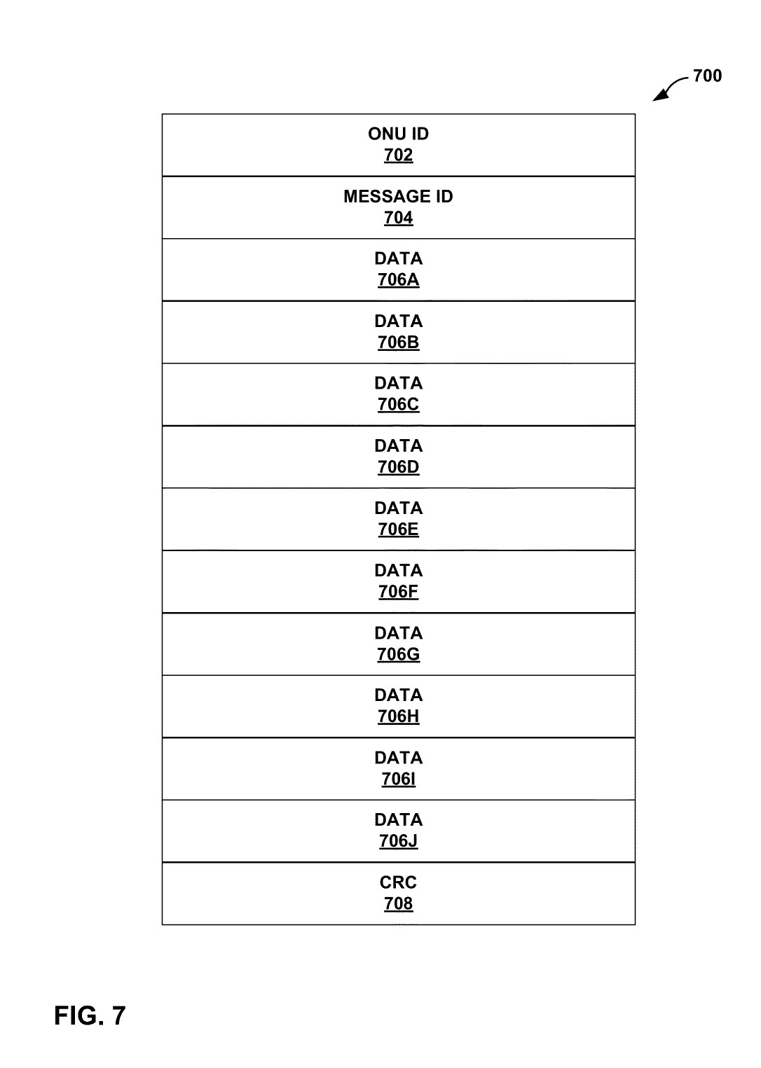

FIG. 7 is a block diagram illustrating an example structure of an adapted DYING_GASP message 700, in accordance with one or more aspects of this disclosure. In the example of FIG. 7, adapted DYING_GASP message 700 follows the structure of a physical layer operations, administration, and maintenance (PLOAM) message, as defined in the current GPON standard. Adapted DYING_GASP message 700 includes thirteen distinct segments (or “octets”), in accordance with the PLOAM message structure defined in the current GPON standard. Each octet may include one byte (i.e., eight bits) of information. In particular, adapted DYING_GASP message 700 includes ONU ID octet 702, message ID octet 704, and cyclic redundancy check (CRC) octet 708. Additionally, adapted DYING_GASP message 700 includes ten data octets 706A-706E (collectively, “data octets 706”).

An ONU that sends adapted DYING_GASP message 700 may populate ONU ID octet 702 with information that identifies the sending ONU. By including such identification information in ONU ID octet 702, the sending ONU may identify itself to the receiving OLT. In turn, the receiving OLT may identify which ONU on the network is at risk for loss of signal due to a fiber bend or impending fiber break. Thus, the OLT may identify the optical fiber line that is experiencing a potential issue, and trigger an alert that identifies the optical fiber line that may need attention.

Message ID octet 704 may include information that identifies what type of message a particular PLOAM message comprises. For example, in accordance with the current GPON standard, the message ID octet of a DYING_GASP message may include the following bit values: 00000011. By implementing one or more techniques described herein, a sending ONU may define a custom 8-bit sequence to identify an adapted DYING_GASP message. More specifically, the sending ONU may use an 8-bit sequence that does not correspond to any particular message types defined in the current GPON standard. In various examples, a sending ONU may define more than one custom 8-bit sequence, thus identifying various sub-categories of adapted DYING_GASP message 700. For example, the sending ONU may use different custom 8-bit sequences to denote different amounts, speeds, etc. of signal strength degradation. In this manner, techniques of this disclosure may enable an ONU experiencing degradation in received signal strength to modify message ID octet 704 in order to inform an upstream OLT of a potential issue with the optical fiber line connected to the ONU.

In cases where the sending ONU generates adapted DYING_GASP message 700 to have a terse structure, the sending ONU may primarily use message ID octet 704 to form adapted DYING_GASP message 700 from the currently defined PLOAM message structure. In other words, the ONU may make minimal or no modifications to data octets 706 in forming adapted DYING_GASP message 700. On the other hand, in cases where the sending ONU uses a more verbose structure in generating adapted DYING_GASP message 700, the ONU may use one or more of data octets 706 to convey information relevant to the received signal strength degradation.

As discussed, the sending ONU may include varying amounts and types of information in adapted DYING_GASP message 700. In these examples, data octets 706 may provide the sending ONU with the resources to convey information relevant to the received signal strength degradation. As described with respect to FIG. 1, examples of information that an ONU may embed in data octets 706 may include signal strength of the received optical signal, a drop level in the signal strength, a function of the drop level and a corresponding time for the drop, etc.

Adapted DYING_GASP message 700 also includes CRC octet 708. As discussed, CRC octet 708 is included in the structure of a PLOAM message as defined in the current GPON standard. According to the current GPON standard, CRC octet 708 may be used to check for the presence and/or severity of any errors in a PLOAM message. Further details about CRC octets, such as CRC octet 708 of adapted DYING_GASP message 700, may be found in the current GPON standard, which is incorporated herein by reference.

The techniques described in this disclosure may be implemented in hardware or any combination of hardware and software (including firmware). Any features described as units, modules, or components may be implemented together in an integrated logic device or separately as discrete but interoperable logic devices. If implemented in hardware, the techniques may be realized in a processor, a circuit, a collection of logic elements, or any other apparatus that performs the techniques described herein. If implemented in software, the techniques may be realized at least in part by a non-transitory computer-readable storage medium comprising instructions that, when executed in a processor, cause the processor to perform one or more of the methods described above. The non-transitory computer-readable medium may form part of a computer program product, which may include packaging materials. The non-transitory computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer readable communication medium that carries or communicates code in the form of instructions or data structures and that can be accessed, read, and/or executed by a computer.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein, may refer to any of the foregoing structures or any other structure suitable for implementation of the techniques described herein. Likewise, the term “control unit,” as used herein, may refer to any of the foregoing structures or any other structure suitable for implementation of the techniques described herein. In addition, in some aspects, the functionality described herein may be provided within dedicated software and hardware units configured to perform the techniques of this disclosure. Depiction of different features as units is intended to highlight different functional aspects of the devices illustrated and does not necessarily imply that such units must be realized by separate hardware or software components. Rather, functionality associated with one or more units may be integrated within common or separate hardware or software components.

Various examples have been described. These and other examples are within the scope of the following claims.

What is claimed is:

1. A method comprising:
determining, by an optical network unit (ONU), at least a first signal strength and a second signal strength of a signal received via an optical fiber to which the ONU connects to communicate with an optical line terminal (OLT);
determining, by the ONU, a rate of signal strength degradation based on the first signal strength and the second signal strength;
comparing, by the ONU, the rate of signal strength degradation to a rate threshold so as to determine a potential issue with the optical fiber; and
based on the comparison, sending, by the ONU, a message to the OLT indicating the potential issue with the optical fiber to which the ONU connects to communicate with the OLT.

2. The method of claim 1, wherein the rate threshold is set such that the ONU determines the potential issue with the optical fiber in enough time to enable the ONU to send the message to the OLT such that the message is successfully received by the OLT and not prevented from reaching the OLT due to the potential issue with the optical fiber.

3. The method of claim 1, wherein the message sent to the OLT comprises a DYING_GASP message specified in the gigabit capable passive optical network (GPON) standard for indicating power failure, the method further comprising:
adapting the DYING_GASP message to indicate the potential issue with the optical fiber.

4. The method of claim 1, wherein determining at least one of the first signal strength and the second signal strength comprises determining at least one received signal strength indication (RSSI) of the signal received via the optical fiber.

5. The method of claim 1, wherein determining the rate of signal strength degradation comprises:
determining the second signal strength within a preprogrammed period of time after determining the first signal strength; and
determining a degradation from the first signal strength to the second signal strength such that the degradation occurs over the preprogrammed period of time.

6. The method of claim 1, further comprising after sending the message indicating the potential issue with the optical fiber, sending a follow-up message that includes information associated with the potential issue with the optical fiber.

7. The method of claim 6, wherein the information included in the follow-up message includes information indicative of at least the determined rate of signal strength degradation.

8. The method of claim 1, further comprising generating the message such that the message includes information associated with the potential issue with the optical fiber.

9. The method of claim 1, wherein sending the message to the OLT comprises sending the message to the OLT within 1 millisecond after determining the second signal strength of the signal received via the optical fiber.

10. The method of claim 1, further comprising storing the message to a cache memory prior to sending the message to the OLT.

11. The method of claim 10, wherein the message is a first message, the method further comprising:
storing, by the ONU to the cache memory, a second message indicating the potential issue with the optical fiber; and
sending, by the ONU, the second message to the OLT via the optical fiber.

12. The method of claim 11, wherein at least one of the first message and the second message comprises a message template that the ONU may complete using information associated with the potential issue with the optical fiber.

13. An optical network unit (ONU) comprising:
a network interface coupled to an optical fiber through which the ONU communicates with an optical line terminal (OLT); and
a control unit that determines at least a first signal strength and a second signal strength of a signal received via the optical fiber, determines a rate of signal strength degradation based on the first signal strength and the second signal strength, compares the rate of signal strength degradation to a rate threshold so as to determine a potential issue with the optical fiber, and based on the comparison, causes the network interface to send a message to the OLT indicating the potential issue with the optical fiber to which the ONU connects to communicate with the OLT.

14. The ONU of claim 13, wherein the message sent to the OLT comprises a DYING_GASP message specified in the gigabit capable passive optical network (GPON) standard for indicating power failure, and wherein the control unit adapts the DYING_GASP message to indicate the potential issue with the optical fiber.

15. The ONU of claim 13, wherein the control unit determines at least one of the first signal strength and the second signal strength of the signal received via the optical fiber at least in part by determining at least one received signal strength indication (RSSI) of the signal received via the optical fiber.

16. The ONU of claim 13, wherein the control unit determines the rate of signal strength degradation at least in part by:
determining the subsequent second signal strength within a preprogrammed period of time after determining the first signal strength;
determining a degradation from the first signal strength to the second signal strength such that the degradation occurs over the preprogrammed period of time.

17. The ONU of claim 13, wherein the control unit, after causing the network interface to send the message indicating the potential issue with the optical fiber, causes the network interface to send a follow-up message that includes information associated with the potential issue with the optical fiber.

18. The ONU of claim 17, wherein the information included in the follow-up message includes information indicative of at least the determined rate of signal strength degradation.

19. The ONU of claim 13, wherein the control unit generates the message such that the message includes information associated with the potential issue with the optical fiber.

20. The ONU of claim 13, wherein the control unit causes the network interface to send the message to the OLT within 1 millisecond after determining the second signal strength of the signal received via the optical fiber.

21. The ONU of claim 13, further comprising a cache memory, wherein the control unit stores the message to the cache memory prior to causing the network interface to send the message to the OLT.

22. The ONU of claim 21, wherein the message is a first message, and wherein the control unit:
stores, to the cache memory, a second message indicating the potential issue with the optical fiber, and
causes the network interface to send the second message to the OLT via the optical fiber.

23. A computer-readable storage device comprising instructions for causing a programmable processor of an optical network unit (ONU) to:
determine at least a first signal strength and a second signal strength of a signal received via an optical fiber to which the ONU connects to communicate with an optical line terminal (OLT);
determine a rate of signal strength degradation based on the determined first signal strength and second signal strength of the signal received via an optical fiber;
compare the rate of signal strength degradation to a rate threshold so as to determine a potential issue with the optical fiber; and
based on the comparison, send a message to the OLT indicating a potential issue with the optical fiber to which the ONU connects to communicate with the OLT.

24. A method comprising:
receiving, by an optical line terminal (OLT) from an optical network unit (ONU), a message via an optical fiber to which the OLT connects to communicate with the ONU, wherein the message indicates a potential issue with the optical fiber;
in response to receiving the message from the ONU, determining, by the OLT, whether the OLT is able to communicate with the ONU via the optical fiber to which the OLT connects to communicate with the ONU;
based on the determination of whether the OLT is able to communicate with the ONU, generating an alert indicating that the optical fiber to which the OLT connects to communicate with the ONU has failed.

25. The method of claim 24, wherein receiving the message comprises receiving the message from the ONU after the ONU detects the potential issue with the optical fiber but prior to the potential issue preventing the message from being received by the OLT.

26. The method of claim 24, wherein the received message comprises a DYING_GASP message specified in the gigabit capable passive optical network (GPON) standard for indicating power failure, and wherein the DYING_GASP message is adapted to indicate the potential issue with the optical fiber.

27. The method of claim 24, further comprising:
injecting, by an optical time domain reflectometer (OTDR) of the OLT, at least one optical pulse into the optical fiber;
receiving, by the OTDR, at least one reflection associated with the injected at least one optical pulse; and
determining, based on an elapsed time between injecting the at least one optical pulse and receiving the at least one reflection, an approximate break location of the optical fiber.

28. The method of claim 24, further comprising:
after receiving the message indicating the potential issue with the optical fiber, receiving a follow-up message that includes information associated with the potential issue with the optical fiber.

29. The method of claim 28, wherein the information included in the follow-up message includes information indicative of at least a rate of signal strength degradation determined by the ONU.

30. The method of claim 24, wherein the received message indicating the potential issue with the optical fiber includes information associated with the potential issue with the optical fiber.

31. The method of claim 24, wherein determining, by the OLT, whether the OLT is able to communicate with the ONU further comprises at least one of 1) determining a number of idle messages received from the ONU, and 2) polling the ONU to solicit a value associated with a backlog of transmissions from the ONU.

32. An optical line terminal (OLT) comprising:
a network interface coupled to an optical fiber through which the OLT communicates with an optical network unit (ONU), wherein the network interface receives, from the ONU, a message via the optical fiber, and wherein the message indicates a potential issue with the optical fiber; and
a control unit that determines, in response to receiving the message from the ONU, whether the OLT is able to communicate with the ONU via the optical fiber to which the OLT connects to communicate with the ONU, and based on the determination, generates an alert indicating that the optical fiber has failed to which the OLT connects to communicate with the ONU.

33. The OLT of claim 32, wherein the received message comprises a DYING_GASP message specified in the gigabit capable passive optical network (GPON) standard for indicating power failure, and wherein the DYING_GASP message is adapted to indicate the potential issue with the optical fiber.

34. The OLT of claim 32, further comprising:
an optical time domain reflectometer (OTDR) that injects at least one optical pulse into the optical fiber and receives at least one reflection associated with the injected at least one optical pulse,
wherein the control unit determines, based on an elapsed time between an injection time of the at least one pulse and a receipt time of the at least one reflection, an approximate break location of the optical fiber.

35. The OLT of claim 34, wherein the network interface, after receiving the message indicating the potential issue with the optical fiber, receives a follow-up message that includes information associated with the potential issue with the optical fiber.

36. The OLT of claim 35, wherein the information included in the follow-up message includes information indicative of at least a rate of signal strength degradation.

37. The OLT of claim 34, wherein the received message indicating the potential issue with the optical fiber includes information associated with the potential issue with the optical fiber.

38. The OLT of claim 34, wherein the control unit determines whether the OLT is able to communicate with the ONU by at least one of:
1) determining a number of idle messages received by the network interface from the ONU, and
2) polling the ONU to solicit a value associated with a backlog of transmissions from the ONU.

39. A network system comprising:
a public network;
at least one optical network unit (ONU), wherein the ONU comprises:
an ONU network interface coupled to an optical fiber through which the ONU communicates with an upstream optical network device; and
an ONU control unit that determines at least a first signal strength and a second signal strength of a signal received via the optical fiber, determines a rate of signal strength degradation based on the first signal strength and the second signal strength, compares the rate of signal strength degradation to a rate threshold so as to determine a potential issue with the optical fiber, and based on the comparison, and causes the ONU network interface to send a message to the upstream optical network device indicating the potential issue with the optical fiber to which the ONU connects to communicate with the OLT; and
an optical line terminal (OLT) that forms at least a portion of the upstream optical network device, wherein the OLT comprises:
an OLT network interface coupled to the optical fiber, wherein the OLT network interface receives the message indicating the potential issue with the optical fiber; and
an OLT control unit that determines, in response to receiving the message from the ONU, whether the OLT is able to communicate with the ONU via the optical fiber to which the OLT connects to communicate with the ONU, and based on the determination, generates an alert indicating that the optical fiber to which the OLT connects to communicate with the ONU has failed.

40. The network system of claim 39, wherein the public network conforms to a gigabit-capable PON (GPON) standard.
